(19) United States
(12) Patent Application Publication
(10) Pub. No.: US 2012/0144134 A1
(43) Pub. Date: Jun. 7, 2012

(54) NONVOLATILE SEMICONDUCTOR MEMORY AND STORAGE DEVICE

(76) Inventor: Yasuyuki NIWA, Chiba-shi (JP)

(21) Appl. No.: 13/235,412

(22) Filed: Sep. 18, 2011

(30) Foreign Application Priority Data
Dec. 2, 2010 (JP) 2010-269189

(51) Int. Cl. G06F 12/00

(52) U.S. Cl. 711/155; 711/E12.001

(57) ABSTRACT

According to one embodiment, a nonvolatile semiconductor memory includes two memory planes in a chip, a I/O circuit in the chip, the I/O circuit shared by the two memory planes, and a control circuit in the chip, the control circuit controlling a write operation, a verify operation and a read operation to the two memory planes independently. Each of the two memory planes comprises a memory cell array and a data register stored write data temporarily. The control circuit configured to transfer the write data to the data registers in the two memory planes in parallel to execute the write and verify operations to every memory plane one by one in a mirroring write mode, and transfer the write data to the data register in one of the two memory planes to execute the write and verify operations in a normal write mode.

### CROSS-REFERENCE TO RELATED APPLICATIONS

This application is based upon and claims the benefit of priority from prior Japanese Patent Application No. 2010-269189, filed Dec. 2, 2010, the entire contents of which are incorporated herein by reference.

### FIELD

Embodiments described herein relate generally to a nonvolatile semiconductor memory and a storage device.

### BACKGROUND

A nonvolatile semiconductor memory, for example, a NAND flash memory, has a high probability of causing an error bit during writing due to miniaturization or the like. To cope with this, it is generally practiced to add an error correction code to write data, and correct read data based on the error correction code by ECC (error correct circuit).

However, an error correction capability of ECC is not unlimited, which means that the error correction is possible only when the number of error bits is within an allowable range.

To cope with this, for example, a so-called mirroring technique in which RAID (Redundant Arrays of Inexpensive Disks) technology is used to write identical data to two locations simultaneously was developed to improve a reliability of a data storage.

Further, in the field of a memory system using a nonvolatile semiconductor memory, an attempt has been made to improve a reliability of a data storage by mirroring write data.

For example, according to a conventional memory system, identical data is simultaneously written to a memory portion (two nonvolatile semiconductor memories) from a memory controller. According to this technique, however, the memory controller converts N-bits data into N/2-bits data, and transfers the resultant data to the memory portion through two data buses. For this reason, time for performing mirror writing requires twice or more of time for not performing the mirror writing.

### BRIEF DESCRIPTION OF THE DRAWINGS

FIGS. 1 and 2 is a diagram each showing a nonvolatile semiconductor memory.

FIG. 3 is a diagram showing a write operation.

FIG. 4 is a diagram showing a read operation.

FIG. 5 is a diagram showing a storage device.

### DETAILED DESCRIPTION

In general, according to one embodiment, a nonvolatile semiconductor memory comprising: two memory planes in a chip; a I/O circuit in the chip, the I/O circuit shared by the two memory planes; and a control circuit in the chip, the control circuit controlling a write operation, a verify operation and a read operation to the two memory planes independently, wherein each of the two memory planes comprises a memory cell array and a data register stored write data temporarily, wherein the control circuit configured to: transfer the write data to the data registers in the two memory planes in parallel to execute the write and verify operations to every memory plane one by one in a mirroring write mode, and transfer the write data to the data register in one of the two memory planes to execute the write and verify operations in a normal write mode.

A storage device comprising: the memory; a controller controlling the memory; and a data bus connected between the memory and the controller, wherein the controller transfers a command signal which selects one of the mirroring write mode and the normal write mode to the memory, and a transfer bit wide of the write data from the controller to the memory in the mirroring write mode and the normal write mode is constant.

An embodiment proposes a mirroring write technique for simultaneously writing identical data into each memory plane in a nonvolatile semiconductor memory (for example, a NAND flash memory) including two memory planes.

Each of the memory planes includes a data resistor, and write data transferred from a memory controller is simultaneously and temporarily stored in data resistors in the two memory planes. Then, writing and verifying are performed for each of the memory planes.

With this arrangement, it is not necessary to reduce a bit wide of a data bus connecting between the memory controller and the nonvolatile semiconductor memory. At the same time, since the memory controller does not need to perform a process of reducing the number of transfer bits of the write data, mirroring write time can be reduced.

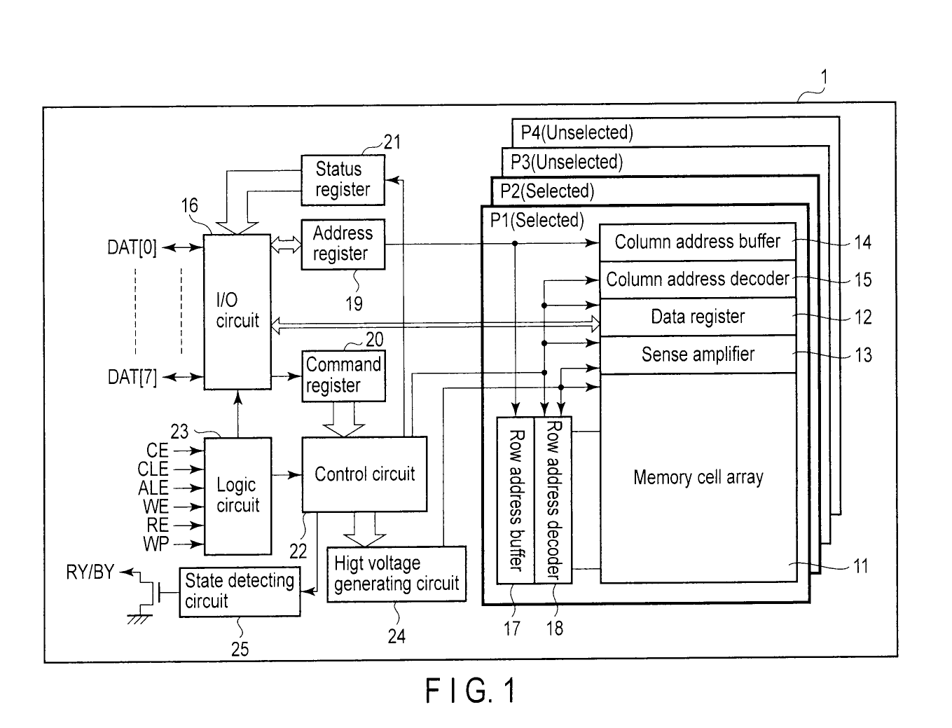

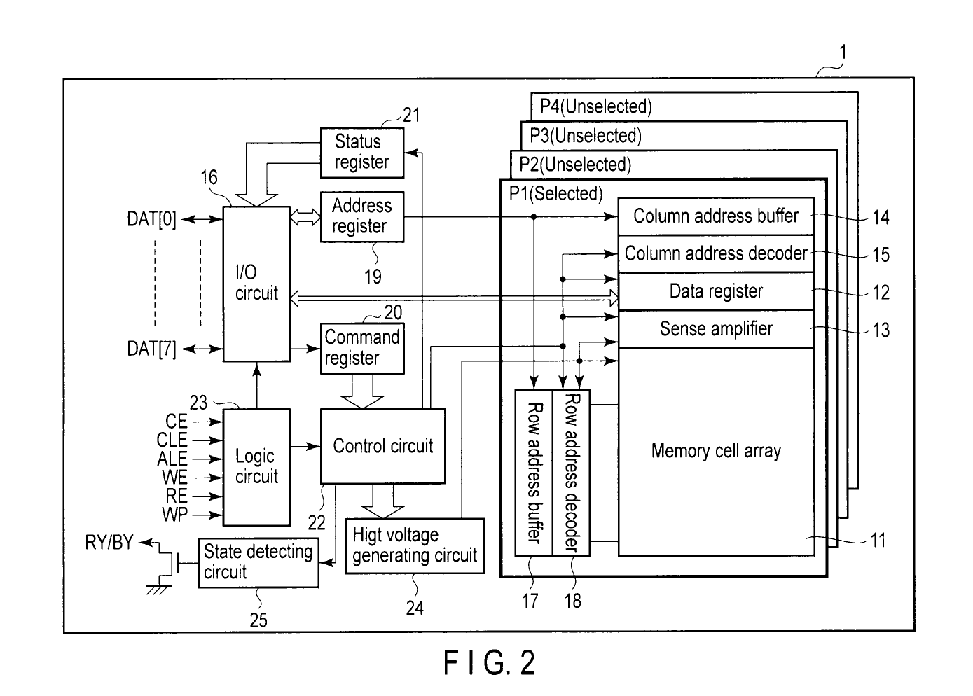

FIGS. 1 and 2 illustrate a nonvolatile semiconductor memory according to the embodiment.

Nonvolatile semiconductor memory 1 is formed inside a single chip (memory chip).

Nonvolatile semiconductor memory 1 includes four memory planes (sometimes referred to as “Districts”) P1, P2, P3, and P4. Although four memory planes are provided in this embodiment, two or more memory planes can serve a purpose of performing the mirroring write according to the embodiment.

Each of four memory planes P1, P2, P3, and P4 includes memory cell array 11 and data register 12 that temporarily stores therein write data and read data.

Sense amplifier 13 senses and amplifies the read data. Column address buffer 14 performs buffering of a column address signal. Column address decoder 15 decodes the column address signal and performs selection of a column of memory cell array 11.

In this embodiment, the write data and the read data (8-bit DAT [7:0]) are transferred between data register 12 and input/output (I/O) circuit 16 for eight columns that are selected.

Row address buffer 17 performs buffering of a row address signal. Row address decoder 18 decodes the row address signal and selects one row (for example, 1 page) of memory cell array 11 that is a target for read and write.

Address register 19 temporarily stores therein the row address signal and the column address signal. Command register 20 temporarily stores therein a command signal for selecting, for example, a mirroring write mode, a normal write mode, a read mode, or the like.

Status register 21 temporarily stores therein a result of a verify operation (status pass or status fail). This result is transferred, through I/O circuit 16, to a memory controller and then to a host controller provided outside nonvolatile semiconductor memory 1.

Control circuit 22 independently controls various operations including write and read operations to and from four memory planes P1, P2, P3, and P4.

Logic circuit 23 receives chip enable signal CE, command latch enable signal CLE, address latch enable signal ALE, write enable signal WE, read enable signal RE, and write protect signal WP, and gives instruction to control circuit 22 about the operation that should be performed based on these control signals.

Chip enable signal CE is for determining selection or non-selection of the chip.

When command latch enable signal CLE is in an enable state, input data (command signal) is transferred to command register 20. When address latch enable signal ALE is in an enable state, input data (row and column address signals) is transferred to address register 19.

When write enable signal WE is in an enable state, a write operation is performed. When read enable signal RE is in an enable state, a read operation is performed. Write protect signal WP is a signal that indicates permission or prohibition of writing. When write protect signal WP is in an enable state, since writing is prohibited, data that has been already stored is not changed.

High-voltage generating circuit 24 generates a high voltage that is used during the write operation and supplies the high voltage to memory cell array 11.

State detecting circuit 25 detects a present state of nonvolatile semiconductor memory 1 and notifies the memory controller of the result. For example, when nonvolatile semiconductor memory 1 is in operation, ready/busy signal RY/BY indicates a busy state, and, when nonvolatile semiconductor memory 1 is on standby, ready/busy signal RY/BY indicates a ready state.

In nonvolatile semiconductor memory 1 having the foregoing configuration, control circuit 22, during the mirroring write mode, for example, simultaneously transfers write data to data register 12 in each of the two selected memory planes P1 and P2, and performs write and verify operations for each of the memory planes as illustrated in FIG. 1.

Further, control circuit 22, during the normal write mode, for example, transfers the write data to data register 12 in the selected memory plane P1, and performs write and verify operations as illustrated in FIG. 2.

According to the foregoing configuration, mirroring is performed by using two memory planes in a single chip, i.e., a single nonvolatile semiconductor memory. Therefore, it is possible to reduce write time through improved access performance as compared with a case in which mirroring is performed by using two chips, i.e., two nonvolatile semiconductor memories.

Specifically, when mirroring is performed by using two nonvolatile semiconductor memories, different electric properties are present in the two nonvolatile semiconductor memories individually due to variations among production lots or the like, and a drop in access performance is predicted because of a difference between busy periods. However, according to the foregoing configuration, such a drop in access performance does not occur because mirroring is performed by using two memory planes in a single nonvolatile semiconductor memory.

Further, when two memory planes in a single nonvolatile semiconductor memory are used to perform mirroring, it is not necessary to change the bit wide of a data bus connecting between the memory controller and the nonvolatile semiconductor memory. In addition, since the memory controller does not need to perform a process of changing the number of transfer bits of the write data, it is possible to reduce the mirroring write time.

However, it is necessary to modify firmware of a memory controller of a conventional product to perform mirroring in a single nonvolatile semiconductor memory. To state it differently, it is possible to selectively produce a conventional product and a product according to this embodiment by merely changing the firmware of the memory controller.

Furthermore, since the mirroring write and the normal write can be selectively performed in a single nonvolatile semiconductor memory by the command signal, it is possible to determine whether mirroring should be performed or not in accordance with a type of a file. For example, a priority is given to a memory capacity for user data so that the data can be stored by using the normal write, and a priority is given to the reliability for data other than the user data, for example, boot information or system information, so that the data can be stored by mirroring.

However, it is necessary to provide a management table for the stored data in the memory controller to perform such an operation.

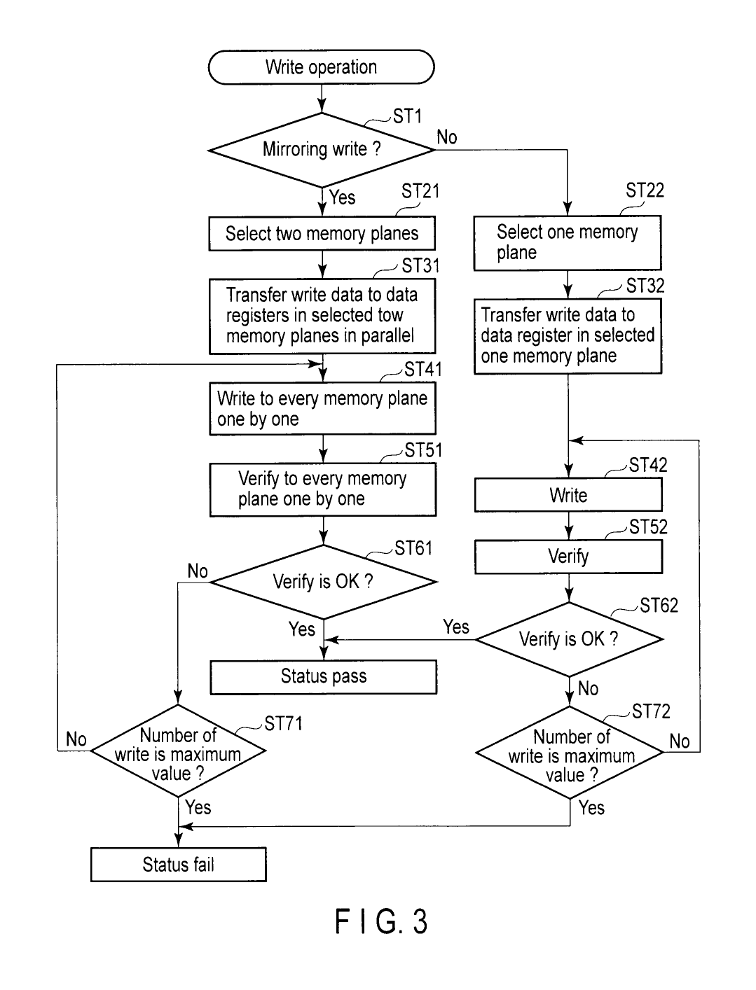

FIG. 3 illustrates a write operation of the nonvolatile semiconductor memory of FIGS. 1 and 2.

The write operation is controlled by control circuit 22 of FIGS. 1 and 2.

First, determination is made whether it is a mirroring write mode or a normal write mode based on the command signal (step ST1).

If it is the mirroring write mode, two memory planes are selected as targets for writing (step ST21).

Thereafter, write data is transferred simultaneously to the data registers in the selected two memory planes (step ST31).

Then, writing is performed based on the values of the write data stored in the data register. Here, the write operation and the verify operation are performed for each plane. However, it is preferable that the write operation and the verify operation in the selected two memory planes be individually performed in synchronism with each other (steps ST41 to ST51).

If a result of the verify operation indicates no good, it is determined whether the number of writing reaches a maximum value or not. If it does not reach the maximum value, the write operation and the verify operation are repeated (steps ST61 to ST71).

Here, the result of the verify operation in the two memory planes is stored in the status register and, at the same time, outputted to outside of the chip as a status read from the I/O circuit based on a status read request from the host controller.

It is preferable that, for example, the result of the verify operation be regarded as a status pass if the results of verify operations in the two memory planes both indicate that the verifications are good, which indicates completion of the writing. Whether it is a status pass or not can be determined by performing logical multiplication (AND) on the results of the verify operations in the two memory planes. Here, “1” is assigned to the result if the verification is good.

In a similar manner, for example, the result of the verify operation can be regarded as a status fail if at least one of the results of verify operations in the two memory planes indicates that the verification is no good, which indicates incompletion of the writing. Whether it is a status fail or not can be determined by performing logical addition (OR) on the results of the verify operations in the two memory planes. Here, “1” is assigned to the result if the verification is no good.

As the status read, further detailed information such as verification information for each bit may be outputted in addition to the foregoing information.

On the other hand, in the normal write mode, one memory plane which is a target for writing is selected (step ST22).

Thereafter, the write data is transferred to the data register in the selected one memory plane (step ST32).

Then, the write operation and the verify operation are repeated until, for example, writing of all bits or a predetermined number of bits or more is completed or until the number of writing reaches a maximum value (steps ST42 to ST72).

In the foregoing writing operation, it is possible to determine whether the mirroring write is performed or not based on the command signal from the host controller. In addition, the host controller determines whether the mirroring write is performed or the normal write is performed according to a type of the write data.

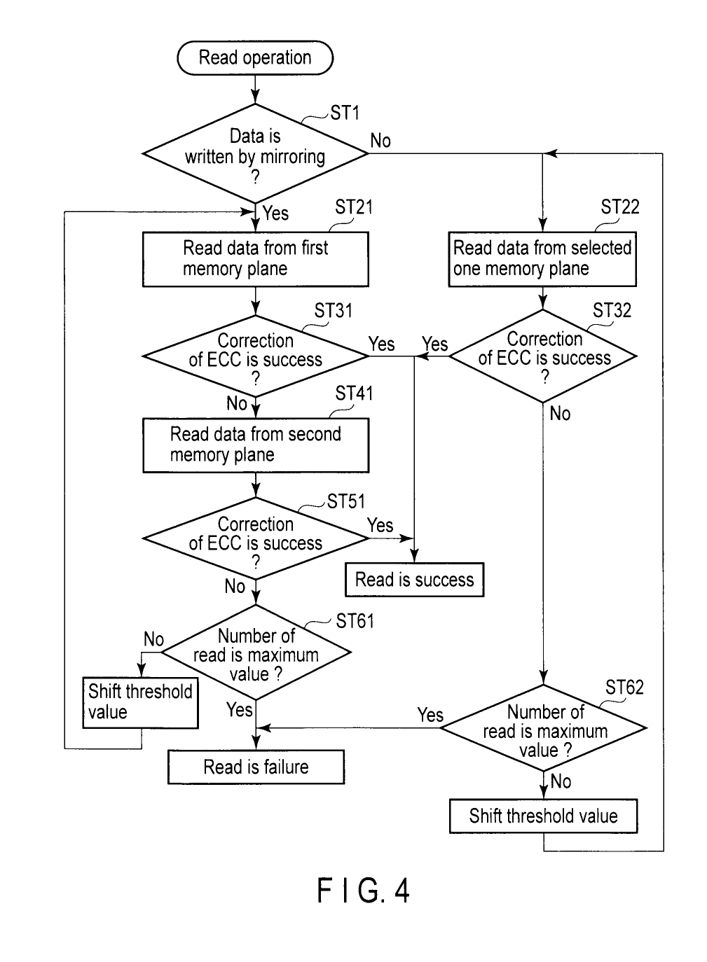

FIG. 4 illustrates the readout operation from the nonvolatile semiconductor memory of FIGS. 1 and 2.

The readout operation is controlled by control circuit 22 of FIGS. 1 and 2.

First, it is determined whether the read data has been written by mirroring or not based on an address, a type, or the like of the read data (step ST1).

If the data has been written by mirroring, first read data is read from one (first memory plane) of two memory planes storing the mirroring data. Error correction of ECC is performed on the first read data. When the error correction is successfully performed, the readout is successful (steps ST21 to ST31).

In contrast, if error correction of ECC fails, second read data is read from the other (second memory plane) of the two memory planes storing the mirroring data. Error correction of ECC is performed on the second read data. When the error correction is successfully performed, the readout is successful (steps ST41 to ST51).

Contrary to this, if error correction of ECC fails, it is determined whether the number of read reaches a maximum value or not.

If the number of read does not reach the maximum value, a readout threshold value is shifted, and third read data is read from the one (first memory plane) of the two memory planes storing the mirroring data, again. If the number of read reaches the maximum value, it turns out to be a read failure (step ST61).

Here, the readout threshold value corresponds to, for example, a read voltage to be applied to a selected word line.

On the other hand, if the data has not been written by mirroring, read data is read from selected one memory plane. Error correction of ECC is performed on the read data. When the error correction is successfully performed, the readout is successful (steps ST22 to ST32).

Contrary to this, if error correction of ECC fails, it is determined whether the number of read reaches a maximum value or not.

If the number of read does not reach the maximum value, a readout threshold value is shifted, and read data is read again from the selected one memory plane. If the number of read reaches the maximum value, it turns out to be a read failure (step ST62).

Here, in the read operation when the data has been written by mirroring, the reason why reading from the other of the two memory planes (switching the memory planes) is prioritized over shifting the readout threshold value if reading from one of the two memory planes fails is that the time required for switching the memory planes is shorter than that for shifting the readout threshold value.

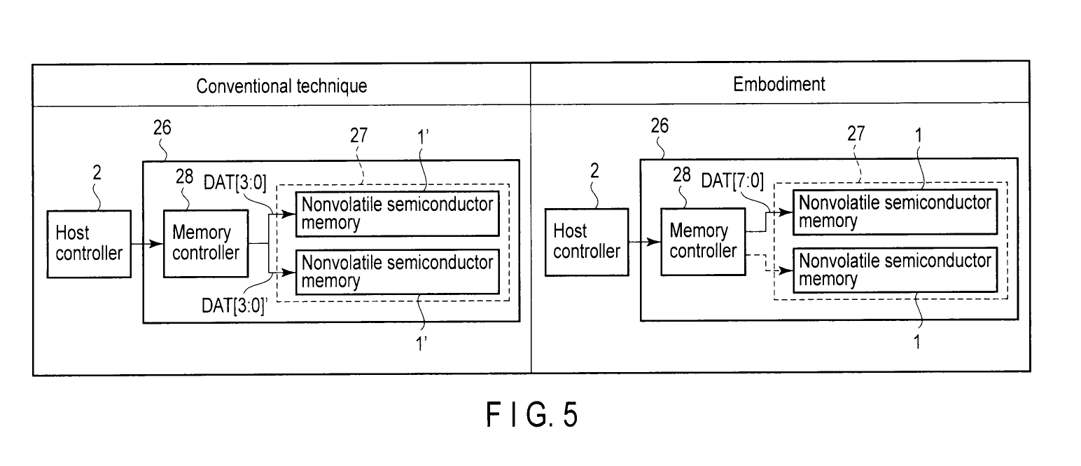

FIG. 5 illustrates a storage device.

Storage device 26 is a data storage product such as, for example, a memory card, a USB memory, or an SSD (solid state drive).

Storage device 26 is provided with memory portion 27 and memory controller 28. Memory portion 27 is provided with nonvolatile semiconductor memories 1 and 1′. Memory controller 28 and nonvolatile semiconductor memories 1 and 1′ are connected with each other via data buses.

In the embodiment, memory controller 28 transfers the command signal from host controller 2 to nonvolatile semiconductor memories 1 and 1′. The command signal here is a command signal for selecting one between the mirroring write mode and the normal write mode.

In addition, transfer bit wide DAT [7:0] of the write data from memory controller 28 to the selected one nonvolatile semiconductor memory 1 is the same for the mirroring write mode and the normal write mode.

The normal write mode is selected when the user data is stored, and the mirroring write mode is selected when data (such as boot information or system information) other than the user data is stored.

In contrast, according to the conventional technique, since a system is arranged for performing the mirroring write always, host controller 2 never outputs a command signal for selecting one between the mirroring write mode and the normal write mode.

Further, transfer bit wide DAT [3:0] and DAT [3:0]′ of the data to be written to the selected two nonvolatile semiconductor memories 1′ from memory controller 28 is half of that for performing the normal write, since mirroring write is performed.

In this way, according to the embodiment, it is possible to shorten the time for performing the mirroring write as compared with the conventional technique.

For a high-capacity data storage product such as SSD, it is also possible to make such an arrangement in which a dedicated management tool is used by the user so that the user can perform setting of on (selected) or off (deselected) of the mirroring write or setting of on or off of the mirroring write according to a type of a file.

According to the foregoing embodiment, it is possible to shorten the time required for mirroring write.

As indicated in the embodiment, when mirroring is performed in a single nonvolatile semiconductor memory, it is possible to use the command signal to selectively perform the mirroring. Alternatively, for example, if mirroring write is always performed, then it is possible to arrange a hardware configuration in such a way that the nonvolatile semiconductor memory copes with mirroring.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory comprising:
two memory planes in a chip; a I/O circuit in the chip, the I/O circuit shared by the two memory planes; and a control circuit in the chip, the control circuit controlling a write operation, a verify operation and a read operation to the two memory planes independently,
wherein each of the two memory planes comprises a memory cell array and a data register stored write data temporarily,
wherein the control circuit configured to:
transfer the write data to the data registers in the two memory planes in parallel to execute the write and verify operations to every memory plane one by one in a mirroring write mode, and
transfer the write data to the data register in one of the two memory planes to execute the write and verify operations in a normal write mode.

2. The memory of claim 1,
wherein the control circuit is configured to execute an AND logic of results of the verify operations in the two memory planes to decide whether each of the verify operations is a status pass or a status fail in the mirroring write mode.

3. The memory of claim 1,
wherein the control circuit is configured to execute the read operation when
the write data is written in the two memory planes by the mirroring write mode.

4. The memory of claim 3,
wherein the control circuit is configured to:
read a first read data from one of the two memory planes in the read operation,
read a second read data from another of the two memory planes when a correction of the first read data is failure, and
reread a third read data from one of the two memory planes by changing a read threshold value when a correction of the second read data is failure.

5. The memory of claim 4,
wherein the correction of the first and second read data is executed by using an error correct circuit.

6. The memory of claim 4,
wherein the control circuit is configured to decide that the read operation is successful when the correction of the first read data is successful.

7. The memory of claim 4,
wherein the control circuit is configured to decide that the read operation is successful when the correction of the second read data is successful.

8. A storage device comprising:
the memory of claim 1;
a controller controlling the memory; and
a data bus connected between the memory and the controller,
wherein the controller transfers a command signal which selects one of the mirroring write mode and the normal write mode to the memory, and a transfer bit wide of the write data from the controller to the memory in the mirroring write mode and the normal write mode is constant.

9. The storage device of claim 8,
wherein the normal write mode is selected when user data is stored in the memory, and the mirroring write mode is selected when data except the user data is stored in the memory.

10. The storage device of claim 9,
wherein the data except the user data includes a boot data and a system data.

11. A nonvolatile semiconductor memory comprising:
two memory planes; a I/O circuit shared by the two memory planes; and a control circuit controlling a write operation, a verify operation and a read operation to the two memory planes independently,
wherein each of the two memory planes comprises a memory cell array and a data register stored write data temporarily,
wherein the control circuit configured to:
transfer the write data to the data registers in the two memory planes in parallel to execute the write and verify operations to every memory plane one by one in a mirroring write mode, and
transfer the write data to the data register in one of the two memory planes to execute the write and verify operations in a normal write mode.

12. The memory of claim 11,
wherein the control circuit is configured to execute an AND logic of results of the verify operations in the two memory planes to decide whether each of the verify operations is a status pass or a status fail in the mirroring write mode.

13. The memory of claim 11,
wherein the control circuit is configured to execute the read operation when
the write data is written in the two memory planes by the mirroring write mode.

14. The memory of claim 13,
wherein the control circuit is configured to:
read a first read data from one of the two memory planes in the read operation,
read a second read data from another of the two memory planes when a correction of the first read data is failure, and
reread a third read data from one of the two memory planes by changing a read threshold value when a correction of the second read data is failure.

15. The memory of claim 14,
wherein the correction of the first and second read data is executed by using an error correct circuit.

16. The memory of claim 14,
wherein the control circuit is configured to decide that the read operation is successful when the correction of the first read data is successful.

17. The memory of claim 14,
wherein the control circuit is configured to decide that the read operation is successful when the correction of the second read data is successful.

18. A storage device comprising:
the memory of claim 11;
a controller controlling the memory; and
a data bus connected between the memory and the controller,
wherein the controller transfers a command signal which selects one of the mirroring write mode and the normal write mode to the memory, and a transfer bit wide of the write data from the controller to the memory in the mirroring write mode and the normal write mode is constant.

19. The storage device of claim 18,
wherein the normal write mode is selected when user data is stored in the memory, and the mirroring write mode is selected when data except the user data is stored in the memory.

20. The storage device of claim 19,
wherein the data except the user data includes a boot data and a system data.
